(19) United States
(12) Patent Application Publication
(10) Pub. No.: US 2016/0034938 A1
(43) Pub. Date: Feb. 4, 2016

(54) METHOD AND APPARATUS FOR AUTOMATED PAYMENT DISTRIBUTION FOR A MULTI-LEVEL SOCIAL NETWORK

(71) Applicants: Wendell Brown, Henderson, NV (US); Alexander Haden Gellis, Malibu, CA (US)

(72) Inventors: Wendell Brown, Henderson, NV (US); Alexander Haden Gellis, Malibu, CA (US)

(21) Appl. No.: 14/815,837

(22) Filed: Jul. 31, 2015

Related U.S. Application Data
(60) Provisional application No. 62/031,638, filed on Jul. 31, 2014.

(51) Int. Cl. G06Q 30/02; G06Q 20/10; G06Q 50/00

(52) U.S. Cl. CPC G06Q 30/0214; G06Q 30/0258; G06Q 30/0269; G06Q 50/01; G06Q 30/0277; G06Q 20/102

(57) ABSTRACT

Certain embodiments are described that allows for automated payment distribution for a multi-level social network. Embodiments of the invention include a multi-tiered social sales network of affiliates and multi-level sales individuals (e.g., national, regional, and/or local) whereby the sale is initiated via a communication, ad, and/or broadcast of a sales opportunity. A purchaser may then act upon the communication, ad, and/or broadcast, whereby incentive payments (e.g., commissions, etc.) are paid out to parties associated with the sale. These parties can involve sales individuals (e.g., in a multi-level sales organization) whom are responsible (directly or indirectly) for the specific sale.

### CROSS REFERENCE TO RELATED APPLICATIONS

This application claims the benefit of U.S. Provisional Patent Application No. 62/031,638, titled “Method and Apparatus for Automated Payment Distribution for a Multi-Level Social Network, filed Jul. 31, 2014, which is incorporated by reference in its entirety herein.

### BACKGROUND

Aspects of the disclosure relate to automated payment methods. More specifically, aspects of the disclosure relate to sales of products and services in a multi-level social sales network. Currently, web and mobile software applications provide for commissions, affiliate fees, cost-per-click (CPC), and cost-per-action (CPA) payments to a single source. However, the existing solutions are limited to payments to a single source and cannot account for incentive payments where multiple parties are involved in a multi-tiered structure.

Embodiments of the invention solve these problems, individually and collectively.

### BRIEF SUMMARY

Certain embodiments are described that allows for automated payment distribution for a multi-level social network. Embodiments of the invention include a multi-tiered social sales network of affiliates and multi-level sales individuals (e.g., national, regional, and/or local) whereby the sale is initiated via a communication, ad, and/or broadcast of a sales opportunity. A purchaser may then act upon the communication, ad, and/or broadcast, whereby incentive payments (e.g., commissions, etc.) are paid out to parties associated with the sale. These parties can involve sales individuals (e.g., in a multi-level sales organization) whom are responsible (directly or indirectly) for the specific sale.

Embodiments of the invention provide many advantages over existing solutions (e.g., offline and non-social network sales), including the ability to facilitate incentive payments (e.g., commissions) to one or more (e.g., multi-level) sales individuals responsible for that sale for sales initiated and competed by either a social or mobile sales network.

### BRIEF DESCRIPTION OF THE DRAWINGS

Aspects of the disclosure are illustrated by way of example. In the accompanying figures, like reference numbers indicate similar elements.

FIG. 1 illustrates a traditional multi-level marketing (MLM) hierarchy. The multi-level hierarchy illustrates four levels of connections;

FIG. 2 illustrates a server computer within the multi-level hierarchical promotion network (MHPN);

FIG. 3 is an exemplary flow diagram illustrating steps involved in making a purchase within the MHPN, according to some embodiments;

FIG. 4 illustrates an example of a computing system in which one or more embodiments may be implemented;

FIG. 5 illustrates an example of a system, according to some embodiments; and

FIG. 6 illustrates an example of a programmatic disbursement of payments, according to some embodiments.

### DETAILED DESCRIPTION

Embodiments of the invention disclose a multi-level hierarchal promotion network to distribute events, activities, and products. The multi-level hierarchical promotion network (MHPN) may provide for real-time listings of all purchases available to a purchaser. The real-time listings can be listed by a sales individual within the promotion network. In some embodiments, the real-time listings can be listed by a sales individual on, but not limited to, a third-party website, a third-party social network, or any other online interface. In some embodiments, the listing (perhaps a central listing that applies to all agents) could be listed by anyone (for example—a non-agent, the listing created by the company itself or another third party). In some embodiments, the listing could be created by a merchant or a venue—for example an event for the Los Angeles Dodgers could be inserted into listings using an Application Program Interface (API), via web data-entry web page, or other means to enable an outside/third-party to create the listing. The MHPN allows a sales individual to promote one or more products and/or activities of their choosing. Additionally, the sales individual(s) may gain further leverage or reach based on higher numbers of sales and/or user engagement.

The MHPN also offers sales individuals the ability to create events (e.g., activities) that can reach everyone connected to the MHPN platform. Further the MHPN provides a sales individual(s) to filter their promotions based on characteristics of the potential purchasers connected to the MHPN. For example, the MHPN may allow the sales individual to filter potential purchasers that have an interest in dogs and reside in Santa Monica, Calif. In another example, the MHPN may allow the sales individual to filter potential purchasers that everyone that rides in Los Angeles, CA.

In another example, a sales individual can create an activity and invite 10,000 potential purchasers. Out of these 10,000 potential purchasers, 100 of them may accept the invitation to the activity. These 100 purchasers may have the option to invite their friends and whoever else they wish to invite. Effectively, these 100 purchasers may now become sales individuals by virtue of extending the invite to their friends, etc. Effectively, the MHPN allows for a massive multi-level distribution platform and promotion platform of sales individuals.

In some embodiments, the MHPN provides a method of an affiliate or commission payment which is paid to one or more sales individuals in a hierarchical order. A sales individual may receive a payment (e.g., commission) for a product or service purchased on the MHPN or third-party networks as described above. The payment (e.g., commission) can be paid to a multi-level hierarchical network of sales individuals.

In some embodiments, the MHPN provides for a coupling of multi-level distribution and a payment system to a social network. A social network can include information describing members of the social network and various connections between the members. Users of the social network can be linked in a hierarchy based multi-level format. The MHPN may determine the amount of pay to be distributed to the various sales individuals across multiple levels when a sale is completed. Payments can be distributed across the various levels when sales individuals of the social network create some pre-established economic value such as closing a sale or acquiring new users. Information about the various purchases can be listed on the social network in the form of a “newsfeed” or “member profile” with the option to purchase or share. Additionally, the purchasable service or product listing can be linked to a sales individual who is linked to other sales individuals in a hierarchical format. The payments can be distributed through the various levels of the hierarchical format after a sale is completed.

In some embodiments, the MHPN provides for a social network coupled with a multi-level product or service distribution and payment system. The MHPN can be described as a virtual space with integrated sales and payment processing that providing unit that can provide each sales individual with a dedicated virtual space on the network. The virtual space can include at least one web page and sales can be made on the web page(s). Payments associated with completion of the sale can be distributed through throughout the hierarchical tree of sales individuals linked to the sales individual. The MHPN may include a database to store the pertinent information about the hierarchy. Additionally, the MHPN allows for payments to paid multi-level across “upline” connections between a sales individual and other sales individuals.

In some embodiments, the MHPN provides for a multi-level payment mechanism for the download of an application (e.g., mobile application).

In some embodiments, the MHPN provides for a “social commerce platform” whereby pricing and availability are published through a mobile device or other electronic network. In some embodiments, the mobile device can include video game consoles, tablets, smart phones, wearable computing devices, and any other hand-held devices. Affiliate or commission payments to sales individuals can be paid to one or more sales individual in a hierarchical order. Sales individuals in a higher (e.g., earlier or more senior) hierarchical status may be paid at a higher percentage compared to payments made to lower sales individuals in the hierarchy.

In some embodiments, the MHPN provides for a method of routing the availability of scarce products, services, tickets, etc. based on prior sales data associated with a sales individual within the network. The availability of scarce products, services, tickets etc. can be made first available to the sales individuals highest in the sales hierarchy. This can provide an incentive for sales individuals to join the network early and also provides a hierarchical sales priority mechanism (e.g., first to purchase) which is coupled to both the join time and date and level of each sales individual in the hierarchy. In some embodiments, sales individuals who are more successful than others can receive first availability to sell their allocation, before their allocation is then assigned to sales individuals lower in the hierarchy.

In some embodiments, the MHPN allows for adjusting the sales commission/affiliate rate (e.g., 4% vs. 5%) based on prior sales data of the sales individual within the network.

In some embodiments, the MHPN provides for a method of automatically posting messages from a “sales server” through its network of hierarchical sales individual's social listings (e.g., “12 tickets available, starting now and available only for the next 10 minutes to tonight's football game!”) to the sales individual's social network. The number of tickets, time order/priority and initial pricing can be based on prior sales data of the sales individual. These messages can be posted automatically (e.g., to a “newsfeed”) or upon approval from the sales individual.

In some embodiments, the MHPN provides for a method of automatically generating sales messages (e.g., advertisements) to be seen and/or transmitted to a sales individual's social network. The sales server can “crawl” a sales individual's friends list and friends' interests to provide a “best fit” offer based on this information. For example, if a sales individual's friend has shown interest on the social network in the band “Coldplay,” the sales server can post a message to the sales individual's “newsfeed” or “wall” where the friend can see the offer. In some embodiments, the sales server can send the message directly to the friend having interest in “Coldplay.”

In some embodiments, the MHPN provides for a multi-level lead generation fee. The multi-level compensation payment system can be coupled to an acquisition of new users or customers. A lead generation fee can be paid out to multiple tiers in a hierarchical network of sales individuals, where more than one sales individual can get compensated for a lead.

In some embodiments, the payment/disbursement of the commission payments could occur via electronic payment systems, including but not limited to, ACH (Automated Clearing House), interbank transfers, Paypal, bank wire transfers, credit to accounts such as credit card accounts, prepaid credit or deposit cards, or other electronic means etc.

In some embodiments, the payment/disbursement of commission payments are sent immediately as each sale is made. In other embodiment, the payment/disbursement of commission payments are combined so that two or more commission payments are sent (to minimize the cost/number of disbursements). Such combined disbursements could be sent upon a time basis (e.g. Every month), or after a certain minimum dollar amount was reached (I.e. Disbursement made upon a minimum of $50 in total accrued payment is owed), etc.

In some embodiments, the advertisements for the products could be shown in a web page advertisement, a mobile advertisement, an in-product advertisement (e.g. Inside a game or inside an app), an advertisement on a wearable computing device (smart watch, smart glasses, activity band, etc.), during an audio program (streaming, downloaded, etc.), during a video program (offline or online), or in any other electronic means.

Several illustrative embodiments will now be described with respect to the accompanying drawings, which form a part hereof While particular embodiments, in which one or more aspects of the disclosure may be implemented, are described below, other embodiments may be used and various modifications may be made without departing from the scope of the disclosure or the spirit of the appended claims.

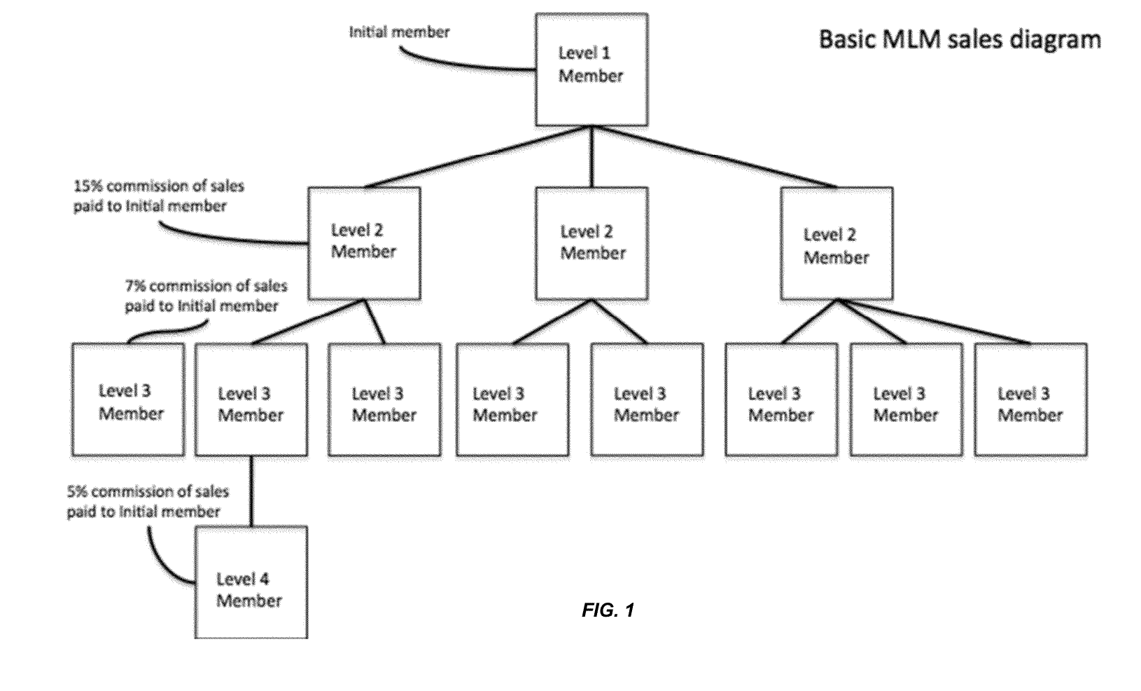

FIG. 1 illustrates a traditional multi-level marketing (MLM) hierarchy. The multi-level hierarchy illustrates four levels of connections. However, it can be appreciated that any level of connections can be part of the hierarchy. The hierarchy begins with a “level 1 member.” The level 1 member may have been the initial member (e.g., sales individual) to join the MLM hierarchy. In turn, the level 1 member may have recruited three more members to join the MLM hierarchy. These three members are illustrated as “level 2 members.” In addition to receiving 100% of the sales commissions on any sales that the level 1 member completes, the level 1 member may also receive 15% of commissions on any sales that the level 2 members complete. This serves as an incentive for members of the MLM hierarchy to recruit more members to join the MLM hierarchy. Each level 2 member may also recruit further members to join the MLM hierarchy, shown as “level 3 members.” The level 1 member may receive 7% of the sales commissions on any sales that the level 3 member completes. Continuing with this process, the level 1 member may receive 5% of sales commissions on any sales that a level 4 member recruited by level 3 members completes.

Traditional MLM hierarchies similar to the one illustrated in FIG. 1 typically operate “offline” and are not capable of automatic distribution of payments. Rather, members typically receive their commission payments in the form of a traditional paper check or other traditional payment method.

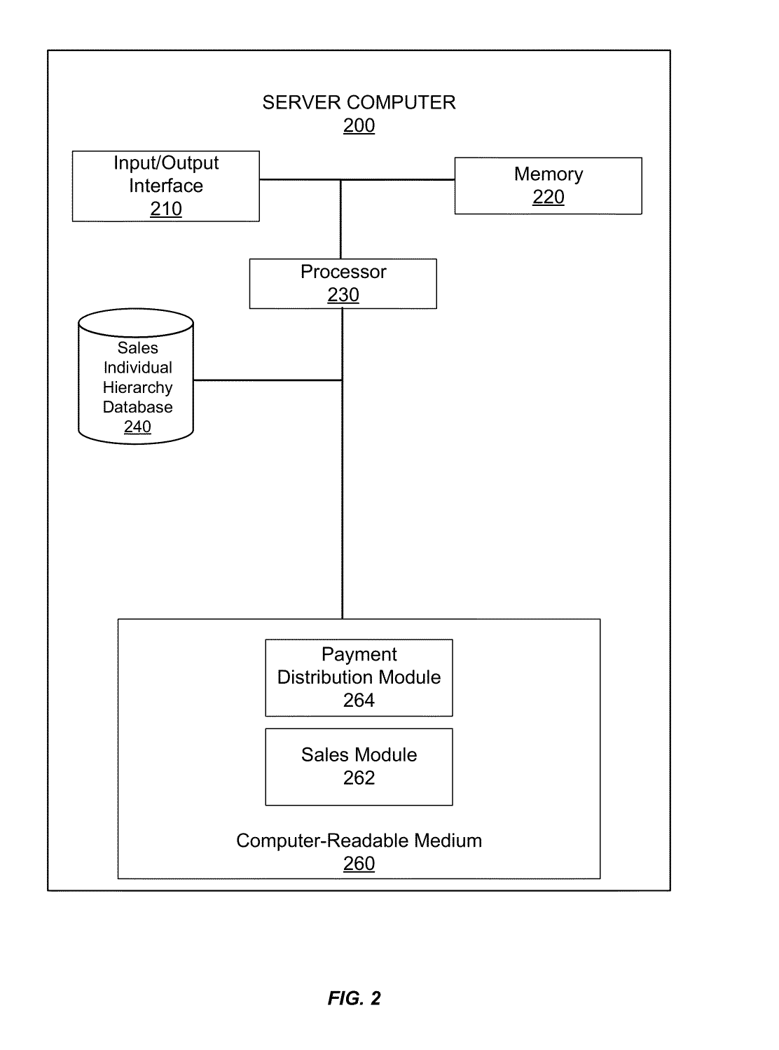

FIG. 2 illustrates a server computer within the multi-level hierarchical promotion network. Server computer 200 includes an input/output interface 210, a memory 220, a processor 230, sales individual hierarchy database 240, and a computer-readable medium 260. In some embodiments, the server computer may reside within the interconnected network multi-level hierarchical promotion network.

The input/output (I/O) interface 210 is configured to receive and transmit data. For example, the I/O interface 210 may receive communications from various sales individuals and other components of the MHPN. The I/O interface 210 may also be used for direct interaction with the server computer. The I/O interface 210 may accept input from an input device such as, but not limited to, a keyboard, keypad, or mouse. Further, the I/O interface may display output on a display device.

Memory 220 may be any magnetic, electronic, or optical memory. It can be appreciated that memory 220 may include any number of memory modules. An example of memory 220 may be dynamic random access memory (DRAM).

Processor 230 may be any general-purpose processor operable to carry out instructions on the server computer 200. The processor 230 is coupled to other units of the server computer 200 including input/output interface 210, memory 220, temporary biometric artifact queue 240, user fraud profile data base 250, and computer-readable medium 260.

The sales individual hierarchy database 240 is configured to store various hierarchical information related to the sales individual connected to the MHPN. This information can include the actual hierarchy of sales individuals connected to the network. The information can also include personal information about the sales individuals including, but not limited to, age, address, join date and time, payment account information, etc.

Computer-readable medium 260 may be any magnetic, electronic, optical, or other computer-readable storage medium. Computer-readable storage medium 260 includes sales module 262 and payment distribution module 264.

Sales module 262 is configured to facilitate sales within the MHPN. The sales module 262 may post advertisements within the social network or facilitate the sending of messages to potential purchasers within the social network with advertisements. The sales module can also track sales of sales individuals and various other analytics pertaining to sales. Upon completion of a sale, the sales module 262 may also update the sales individual hierarchy database 240.

Payment distribution module 264 is configured to distribute incentive or commission payments to the sales individuals within the MHPN. The payment distribution module 264 may interface with, via input/output module 210, with various third-party payment entities to distribute payments to the sales individuals. The payment distribution module 264 may receive a communication from the sales module 262 upon the completion of a sale. The payment distribution module 264 may then determine the appropriate incentives or commissions to be paid based on the hierarchy stored in the sales individual hierarchy database. Upon making this determination, the payment distribution module 264 may automatically facilitate the appropriate payments to the sales individuals associated with completion of the sale.

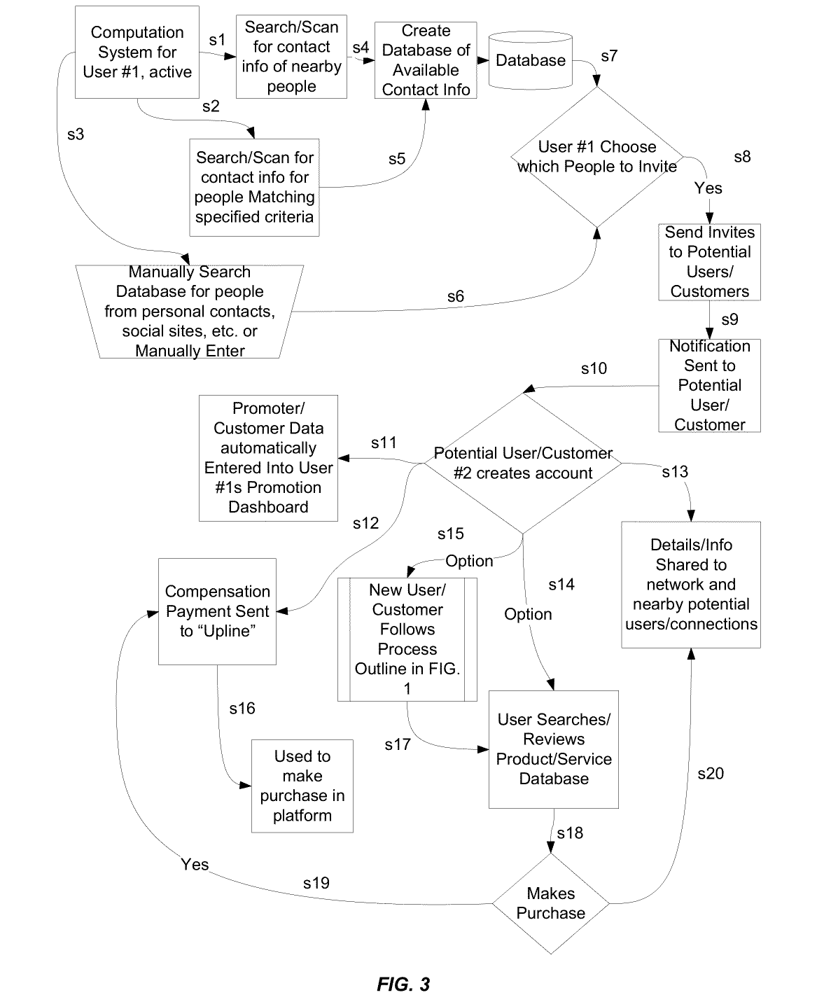

FIG. 3 is an exemplary flow diagram illustrating steps involved in making a purchase within the MHPN, according to some embodiments. The flow begins when a computer system for a first user is activated. In step s1, the computer system can search/scan for contact information of nearby people. Alternatively, in step s2, the computer system can search/scan for contact information of people matching a specified criteria. Alternatively, in step s3, the computer system can manually search a database for people from personal contacts, social sites, etc. or manually entered contacts. In step s4 and s5, in response to either searching/scanning for contact information of nearby people or searching/scanning for contact information of people matching a specified criteria, a database of available contact information can be created. In step s6 and s7, the user can choose which people to invite. In step s8, invites can be sent to potential users/customers from the selected users. In step s9, a notification can be sent to the potential users/customers. In step s 10, the potential user/customer can create an account within the MHPN. In step s11, the user/customer information can automatically be entered into the first user's promotion dashboard. In step s12, a compensation payment can be sent to all users “upline” in the hierarchy to the newly registered user/customer. In step s13, details and/or information can be shared to the MHPN and nearby potential users/customers. In step s14, the user can search/review the product/service database. In step s15, the new user/customer can restart the flow at steps s1, s2, or s3. In step s16, a purchase can be made in the MHPN. In step s17, the user can search/review the product/service database upon restarting the process. In step s18, the user can make a purchase. In step s19, compensation can be sent “upline” in the hierarchy to all users associated with the purchase. In step s20, details and/or information can be shared to the MHPN and nearby potential users/customers.

In some embodiments, communications to users may be provided via webpages. For example, in step s8 where invites can be sent to potential users/customers from the selected users, and/or in step s14 where the user can search/review the product/service database, the invite and/or product/service information may be communicated via a webpage. Server computer 200 or some other device may be configured to provide code or other computer executable instructions that can be embedded within webpage code. The webpage may be hosted by the MLM system, or may be a third party webpage hosted by one or more third party servers. Once embedded within the webpage code, the webpage include a link to the invite. In another example, the embedded code within the webpage may provide links to product/service information, as well as to make a purchase in the MHPN. In another example, the embedded code may provide an embedded user interface within the webpage for direct interaction with the MLM system. In some embodiments, the webpage may be a social networking page, such as a user homepage, wall, feed, etc.

In some embodiments, the embedded code within a webpage may be used to facilitate compensation tracking within the MLM system. For example, each user may be associated with a unique user identifier, or the like, which may be included within the embedded code for invites and/or product/service messages. Upon a new user accessing the webpage and performing registration, the referring user compensation payment to the direct referring user “upline” in the hierarchy to the newly registered user may be determined and compensated, and users “upline” to the referring user may also be determined and compensated at step s12. Additionally or alternatively, upon a user accessing the webpage and making a purchase, the “upline” users may be determined based on the user identifier of the purchase referring user, and compensation appropriate compensation may be provided in step s19. In some embodiments, each referring user may be associated with a different embeddable code, and as such users may be registered within the MLM hierarchy simply by interacting with particular embedded code of webpages. Advantageously, the volume of frequency of user device interactions required to operate the MLM system are reduced. For example, new users are not required to manually submit a referrer user identifier or other the like to the MLM system.

In some embodiments, the MLM computer system may be coupled to (e.g., via the Internet) and interact with mobile device applications operating on user mobile devices. The mobile device application may include a social networking application. The user interactions discussed herein performed by the user may be received as user device inputs, and sent to the computer system of the MLM, which is configured to host the social network. Similarly, communications from the MLM computer system to users may be sent to user mobile devices, such as notifications of user registration, compensation, etc. using the social network. In another example, users may communicate with each other and share information related to the MLM system with mobile devices via the social network, or otherwise. For example, the user invites and/or product/service information may be sent to mobile devices at steps s8 and s14 via an application chat or messaging interface of the social network application. Other communication channels or applications of mobile devices may alternatively or additionally be used, such as a push alert, email, and/or short messaging service (SMS) text.

In some embodiments, in step s2, the computer system can search/scan for contact information of people based on location, which may be determined based on the location of the user mobile devices (e.g., such as using global positioning systems (GPS), cell-tower triangulation, local area networks, location services, etc.). Additionally or alternatively, the search/scan for contact information at step s2 may be based on user contacts stored on the user mobile device.

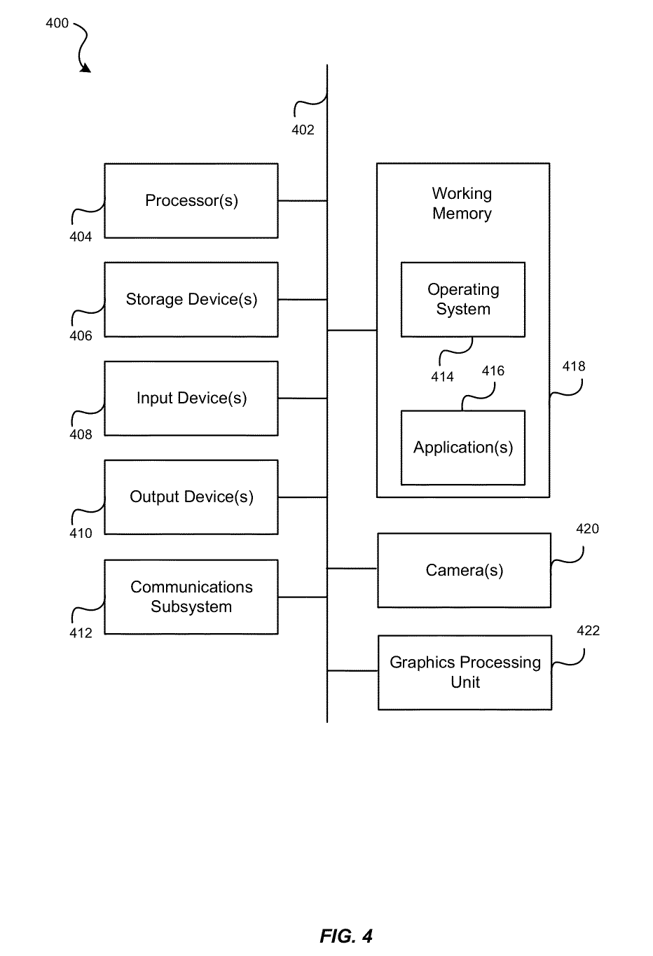

FIG. 4 illustrates an example of a computing system in which one or more embodiments may be implemented.

A computer system as illustrated in FIG. 4 may be incorporated as part of the above described computerized device. For example, computer system 400 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones, wearable computing devices, and any other hand-held devices. FIG. 4 provides a schematic illustration of one implementation of a computer system 400 that can perform the methods provided by various other implementations, as described herein, and/or can function as the host computer system, a remote kiosk/terminal, a point-of-sale device, a telephonic or navigation or multimedia interface in an automobile, a computing device, a set-top box, a table computer and/or a computer system. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 402 (or may otherwise be in communication, as appropriate). The hardware elements may include one or more processors 404, including without limitation one or more general-purpose processors and/or one or more special-purpose processors (such as digital signal processing chips, graphics processing units 422, and/or the like); one or more input devices 408, which can include without limitation one or more cameras, sensors, a mouse, a keyboard, a microphone configured to detect ultrasound or other sounds, and/or the like; and one or more output devices 410, which can include without limitation a display unit such as the device used in implementations of the invention, a printer and/or the like. Additional cameras 420 may be employed for detection of user's extremities and gestures. In some implementations, input devices 408 may include one or more sensors such as infrared, depth, and/or ultrasound sensors. The graphics processing unit 422 may be used to carry out the method for real-time wiping and replacement of objects described above.

In some implementations of the implementations of the invention, various input devices 408 and output devices 410 may be embedded into interfaces such as display devices, tables, floors, walls, and window screens. Furthermore, input devices 408 and output devices 410 coupled to the processors may form multi-dimensional tracking systems.

The computer system 400 may further include (and/or be in communication with) one or more non-transitory storage devices 406, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 400 might also include a communications subsystem 412, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 412 may permit data to be exchanged with a network, other computer systems, and/or any other devices described herein. In many implementations, the computer system 400 will further comprise a non-transitory working memory 418, which can include a RAM or ROM device, as described above.

The computer system 400 also can comprise software elements, shown as being currently located within the working memory 418, including an operating system 414, device drivers, executable libraries, and/or other code, such as one or more application programs 416, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 406 described above. In some cases, the storage medium might be incorporated within a computer system, such as computer system 400. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 400 may be omitted or may be implemented separate from the illustrated system. For example, the processor 404 and/or other elements may be implemented separate from the input device 408. In one implementation, the processor may be configured to receive images from one or more cameras that are separately implemented. In some implementations, elements in addition to those illustrated in FIG. 4 may be included in the computer system 400.

Some implementations may employ a computer system (such as the computer system 400) to perform methods in accordance with the disclosure. For example, some or all of the procedures of the described methods may be performed by the computer system 400 in response to processor 404 executing one or more sequences of one or more instructions (which might be incorporated into the operating system 414 and/or other code, such as an application program 416) contained in the working memory 418. Such instructions may be read into the working memory 418 from another computer-readable medium, such as one or more of the storage device(s) 406. Merely by way of example, execution of the sequences of instructions contained in the working memory 418 might cause the processor(s) 404 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 400, various computer-readable media might be involved in providing instructions/code to processor(s) 404 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 406. Volatile media include, without limitation, dynamic memory, such as the working memory 418. Transmission media include, without limitation, coaxial cables, copper wire and fiber optics, including the wires that comprise the bus 402, as well as the various components of the communications subsystem 412 (and/or the media by which the communications subsystem 412 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 404 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various implementations of the invention.

The communications subsystem 412 (and/or components thereof) generally will receive the signals, and the bus 402 then might carry the signals (and/or the data, instructions, etc. carried by the signals) to the working memory 418, from which the processor(s) 404 retrieves and executes the instructions. The instructions received by the working memory 418 may optionally be stored on a non-transitory storage device 406 either before or after execution by the processor(s) 404.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

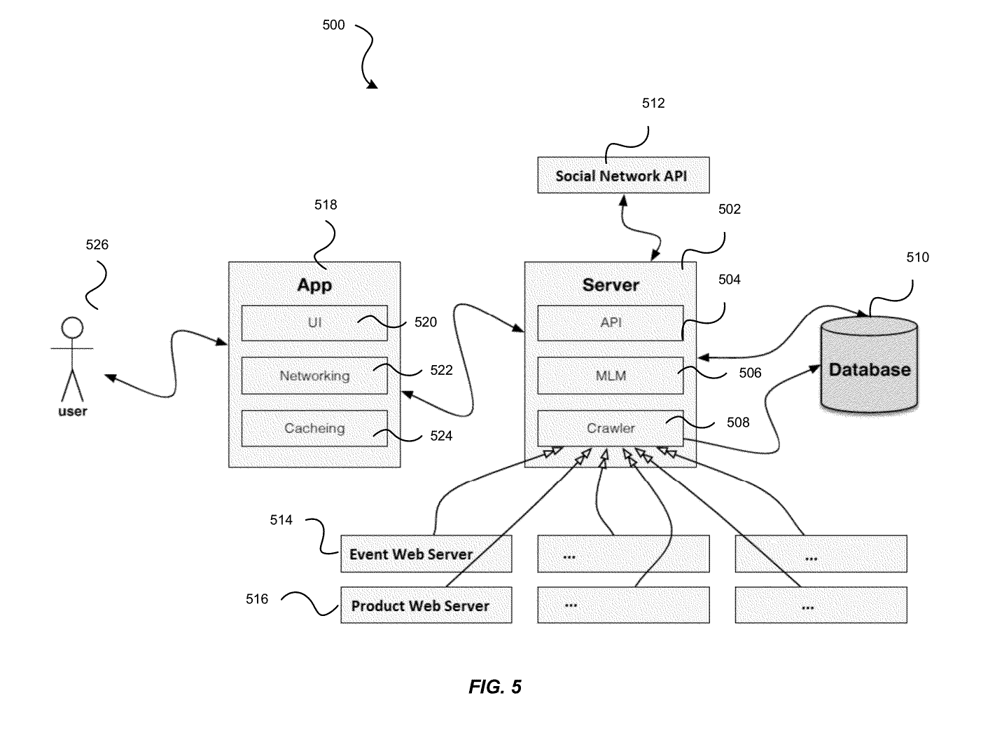

FIG. 5 illustrates an example of a system 500, according to some embodiments. The system 500 may include a server 502 and a database 510, which may be implemented as the above described server computer 200. Server 502 may include an API module 504, an MLM module 506, and a crawler module 508. The API module 504 may be configured to interact with various APIs of third party systems to enable interoperability with the MLM system. For example, the API module 504 may be configured to interface with a social network API 512 of a social network, which may be hosted by the MLM system or a separate third party system, to facilitate user invitations, registrations, share products/services, completing purchases, etc. via the social network (e.g., messages, newsfeed items, etc.).

The MLM module 506 may be configured to perform the functionality discussed herein with respect to operating and managing the MLM network. As such MLM module 506 may include the payment distribution module 264 and/or sales module 262, as discussed above in connection with computer server 200 of FIG. 2.

The crawler module 508 may be configured to collect data associated with events, products, and/or services. These events, products, or services may be provided to users of the MLM network as discussed herein. As such, the crawler module 508 may be configured to connect with event web servers 514 and/or product web servers 516 via a network (e.g., the Internet). Event web servers 514 may be configured to host event webpages, or otherwise provide data, associated with events. Some example event webpages may include EventBrite, Meetup, BandslnTown, Eventful, or SeatGeak. Product web servers 516 may be configured to host product and/or service webpages, or otherwise provide data, associated with products and/or services. The crawler module 508 may be configured to crawl such webpages to collect events, products, and/or services that may be offered via the MLM network. Additionally or alternatively, the data defining events, products, and/or services may be sent by one or more third party servers. For example, the server 502 may be configured to provide a webpage or an API that allows third part devices to submit event, product, and/or service data to the server 502.

The database 510 may be configured to store data associated with the MLM network. For example, database 510 may store event, product, and/or service data that have been collected by the server 502. Database 510 may be further configured to store the sales individual hierarchy, as discussed above for the sales individual hierarchy database 240. In some embodiments, where the MLM system also provides a social network, the database 510 may be further configured to store user social networking data, such as user accounts, connections, groups, posts, feed items, profiles, etc. While only a single server 502 and database 510 is shown in FIG. 5, system 500 may include one or more (e.g., distributed, cloud, etc.) servers 502 and/or on or more databases 510 in various embodiments.

The system 500 may further include one or more user devices 518, which may be connected with the server 502 via a network (e.g., the Internet). Each user device 518 may be associated with a user, such as based on the user providing login data or other identifying data to the server 502 for access to the MLM network. In some embodiments, the user device 518 may be a mobile device, such as a smartphone, tablet, wearable device (e.g., electronic watch, eyewear, etc.). The user device 518 may be configured to execute an application that allows the user to interact with the MLM network and/or social network provided by the server 502, such as a mobile application where the user device 518 is a mobile device. The user device 518 may include a user interface module 520, a networking module 522, and a caching module 524. The user interface module 520 may be configured to provide user interfaces to a display of the user device 518 to perform the user-based functionality discussed herein, such as registration, inviting other users, searching/viewing products, events, or services, purchases, social network functionality (e.g., profiles, friends, groups, etc.), payment disbursements, etc. The networking module 522 may be configured to connect the user device 518 to the server 502 via a network such as the Internet. The caching module 524 may be configured to locally store, such as within a hard drive or other storage medium of the user device 518, various data resources received from the server 502 to reduce network data loads.

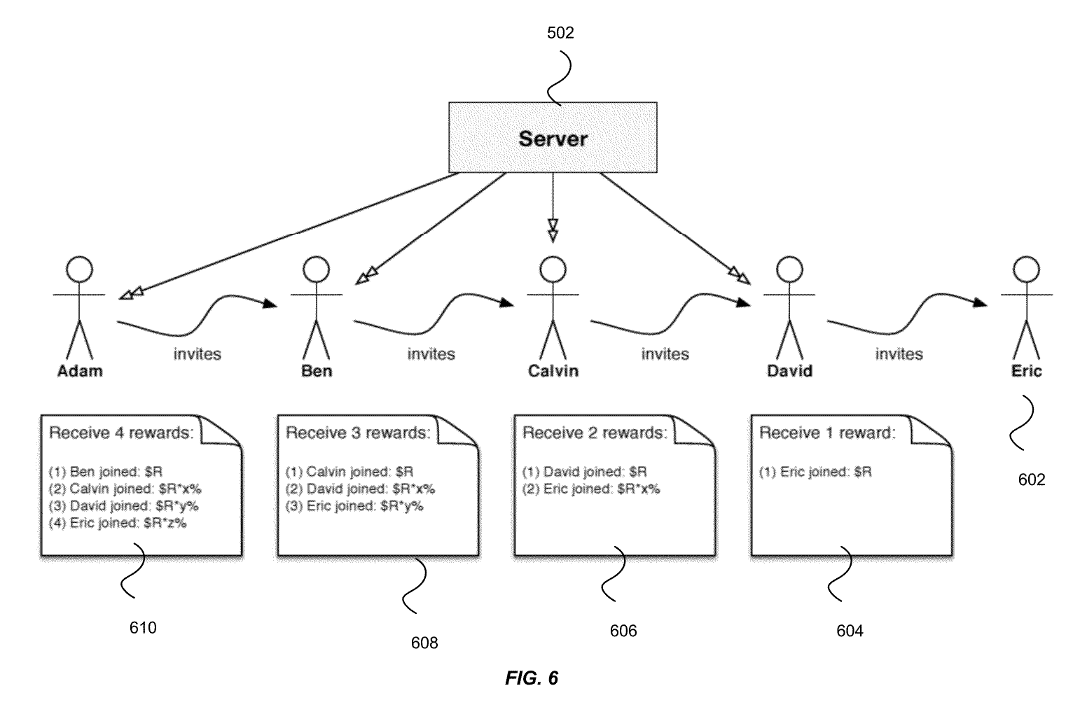

FIG. 6 illustrates an example of a programmatic disbursement of payments, according to some embodiments. As discussed above in connection with the flow diagram of FIG. 3, the server 500 may be configured to provide “upline” compensation payments for new registered users (in step s12) and “upline” compensation payments for user purchases (in step 18).

With reference to FIG. 6, when user 602 registers with the MLM system, the server 500 may be configured to determine a hierarchy indicative of other users within a recruitment chain in recruiting the registered user. Here, users 604-610 represent the other users within the recruitment chain in recruiting the registered user 602. The other users 604-610 are also arranged in a hierarchy based on the recruitment chain, where the user 610 invited the user 608, the user 608 invited the user 606, and the user 606 invited the user 604- who invited the new registered user 602.

When the user 602 joins the MLM network, the server 500 may be configured to determine commission percentages for each of the other users. For example, the direct upstream user 604 may be paid a value $R representing a currency amount. Then each user within the recruitment chain may be rewarded a predetermined portion of the value $R, such as X%, Y%, and Z% for users 606, 608, and 610, respectively. Similarly, when the user 604 registered based on an invitation from the user 606, the user 606 may be the direct upstream user that is paid the value $R. The upstream user 608 may receive a predetermined portion of the value $R, such as X% and Y% for users 608 and 610, respectively. New users can be similarly added to the recruitment chain and MLM hierarchy.

The discussion above with respect to new user registration may also be applicable to user purchases. For example, if user 602 makes a purchase, the direct upstream user 604 may be paid a value $R. Then each “upline” user within the recruitment chain may be rewarded a predetermined portion of the value $R, such as X%, Y%, and Z% for users 606, 608, and 610, respectively. In some embodiments, the discount %ages for upstream user level and the value $R may be predefined, such as based on static values or algorithmically defined variable values (e.g., $R may vary based on the value of a user purchase).

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

What is claimed is:

1. A method for facilitating payment distribution in a sales network, the method comprising:
registering a user with the sales network;
updating, within a database, a hierarchy indicative of other users within a recruitment chain in recruiting the registered user;
detecting a purchase made within the sales network by the registered user;
determining commission percentages for each of the other users based on the detected purchase; and
disbursing commission payments to each of the other users based at least in part on the commission percentages and purchase price of the purchase.

2. The method of claim 1 further comprising, prior to registering the user with the sales network, transmitting an advertisement message to the user.

3. The method of claim 2, wherein the advertisement message is transmitted to the user based on matching the user with a predefined interest.

4. The method of claim 2, wherein:
the advertisement message is transmitted to the user via embedded code within a webpage; and
determining the commission percentages for each of the other users includes identifying at least one user based on the embedded code.

5. The method of claim 1 further comprising sending an invitation to the user to join the sales network, wherein the invitation is transmitted to the user via embedded code within a webpage; and
wherein updating, within the database, the hierarchy indicative of other users within the recruitment chain in recruiting the registered user includes identifying at least one user based on the embedded code.

6. The method of claim 1, wherein the sales network is a social network.

7. The method of claim 1, further comprising, prior to registering the user with the sales network, publishing the advertisement on a web page.

8. The method of claim 1, further comprising, prior to registering the user with the sales network, publishing the advertisement on a social network.

9. The method of claim 1, wherein the database comprises date and time information pertaining to registration of the user and the other users with the sales network.

10. A system, comprising:
a server configured to:
register a user with the sales network;
update, within a database, a hierarchy indicative of other users within a recruitment chain in recruiting the registered user;
detect a purchase made within the sales network by the registered user;
determine commission percentages for each of the other users based on the detected purchase; and
disburse commission payments to each of the other users based at least in part on the commission percentages and purchase price of the purchase.

11. The system of claim 10, wherein the server is further configured to, prior to registering the user with the sales network, transmit an advertisement message to the user.

12. The system of claim 11, wherein the advertisement message is transmitted to the user based on matching the user with a predefined interest.

13. The system of claim 11, wherein:
the advertisement message is transmitted to the user via embedded code within a webpage; and
the server configured to determine the commission percentages for each of the other users includes the server being configured to identify at least one user based on the embedded code.

14. The method of claim 10, wherein:
the server is further configured to send an invitation to the user to join the sales network;
the invitation is transmitted to the user via embedded code within a webpage; and
the server configured to update, within the database, the hierarchy indicative of other users within the recruitment chain in recruiting the registered user includes the server being configured to identify at least one user based on the embedded code.

15. The system of claim 10, wherein the sales network is a social network.

16. The system of claim 10, wherein the server is further configured to, prior to registering the user with the sales network, publish the advertisement on a web page.

17. The system of claim 10, wherein the server is further configured to, prior to registering the user with the sales network, publish the advertisement on a social network.

18. The system of claim 10, wherein the database comprises date and time information pertaining to registration of the user and the other users with the sales network.

19. An apparatus, comprising:
processing circuitry configured to:
receive, from a mobile device associated with a user, an indication that the user has accepted an invitation from a referring user to join a sales network;
register the user with the sales network based on the indication;
update, within a database, a hierarchy indicative of other users within a recruitment chain in recruiting the registered user based at least in part on the referring user;
detect a purchase made within the sales network by the registered user;
determine commission percentages for each of the other users based on the detected purchase; and
disburse commission payments to each of the other users based at least in part on the commission percentages and purchase price of the purchase.

20. The apparatus of claim 19, wherein the invitation includes a social network mobile application message.
